(19) United States
(12) Patent Application Publication
(10) Pub. No.: US 2002/0113148 A1
(43) Pub. Date: Aug. 22, 2002

(54) Immersion nozzle for continuous casting

(76) Inventors: Noriyoshi Naruse, Ena-Gun (JP); Hideaki Mizuno, Ena-Gun (JP)

Correspondence Address: KODA & ANDROLIA, Suite 3850, 2029 Century Park East, Los Angeles, CA, 90067-3024, US

(21) Appl. No.: 10/016,443

(22) Filed: Oct. 25, 2001

(30) Foreign Application Priority Data
Oct. 26, 2000 (JP) P2000-326903

(51) Int. Cl. A62C 37/20

(52) U.S. Cl. 239/562

(57) ABSTRACT

An immersion nozzle for continuous casting includes a body having a hollow interior and an open end and a bottom, the body including a peripheral wall and having a plurality of discharge holes formed through the peripheral wall so as to communicate with the interior of the body and so as to be located near one of the ends thereof, and a partition wall formed integrally on the bottom of the body so as to partition a sectional area of the body substantially in equal parts according to the number of discharge holes so that amounts of a molten metal discharged out of the respective discharge holes are substantially equalized, the partition wall having an upper end located above the discharge holes and below a meniscus of the molten metal.

### BACKGROUND OF THE INVENTION

1. Field of the Invention

This invention relates to an immersion nozzle suitable for use in continuous casting.

2. Description of the Related Art

An immersion nozzle for continuous casting generally has two discharge holes formed in a lower portion thereof so as to communicate with a hollow interior of the nozzle. The immersion nozzle is immersed into molten steel so that the molten steel is supplied through the discharge holes. The immersion nozzle has an upper open end provided with a gate whose opening is varied so that a casting speed is adjusted.

However, when the opening of the gate is reduced in order that the casting speed may be decreased, the molten steel flows obliquely but not right below. As a result, the molten steel flows obliquely downward along the nozzle interior, pressing a well of the molten steel. The molten steel further flows obliquely downward such that a larger amount of molten steel is caused to flow out of one of the discharge holes than out of the other discharge hole. Thus, an amount of molten steel discharged through one discharge hole differs from one discharged through the other discharge hole. This is referred to as “one-sided flow.” Upon occurrence of the one-sided flow, a thickness of a solidified shell formed at the side of a larger amount of molten steel discharged in a mold becomes small such that the shell sometimes breaks when taken out of the mold. Furthermore, the one-sided flow results in a reduction in the quality of steel.

### SUMMARY OF THE INVENTION

Therefore, an object of the present invention is to provide an immersion nozzle which can prevent the one-side flow of molten steel when the opening of the gate is reduced.

Another object of the invention is to provide an immersion nozzle in which amounts of molten steel discharged out of a plurality of discharge holes respectively can substantially be equalized by utilizing a head pressure of the molten steel gathered up to a meniscus line in the nozzle.

Further another object of the invention is to provide an immersion nozzle in which the casting speed can easily be adjusted.

The invention provides an immersion nozzle for continuous casting comprising a body having a hollow interior and an open end and a bottom, the body including a peripheral wall and having a plurality of discharge holes formed through the peripheral wall so as to communicate with the interior of the body and so as to be located near one of the ends thereof, and a partition wall formed integrally on the bottom of the body so as to divide a sectional area of the body substantially in equal parts according to the number of discharge holes so that amounts of a molten metal discharged out of the discharge holes are substantially equalized, the partition wall having an upper end located above the discharge holes and below a meniscus line.

According to the above-described immersion nozzle, when the gate is full open, the molten metal flowing into the nozzle is divided by the partition wall so that amounts of molten metal discharged out of the respective discharge holes are substantially equalized. When the opening of the gate is reduced, the molten metal flows to a well of the molten metal in the nozzle diagonally from above. However, the force of the molten metal flowing obliquely downward is blocked by the partition wall. Accordingly, amounts of molten metal discharged out of the respective discharge holes are substantially equalized, whereupon the one-sided flow of the molten metal can be prevented.

In a preferred form, the upper end of the partition wall is located substantially midway between an open upper edge of an inner opening of each discharge hole and the meniscus line. Accordingly, the force of the molten metal flowing obliquely downward is blocked by the partition wall. Moreover, the head pressure of the molten metal accumulated between the upper end of the partition wall and the meniscus line causes the molten metal to flow downward. Consequently, amounts of molten metal discharged out of the respective discharge holes are substantially equalized, where upon the one-sided flow of the molten metal can be prevented more reliably.

In another preferred form, the immersion nozzle further comprises a slide gate provided for opening and closing the open end thereof. Consequently, since the casting speed is easily adjusted, the one-sided flow of the molten metal can be prevented more reliably.

### BRIEF DESCRIPTION OF THE DRAWINGS

Other objects, features and advantages of the present invention will become clear upon reviewing the following description of an embodiment, made with reference to the accompanying drawings, in which:

FIG. 1 is a sectional view of an immersion nozzle of one embodiment in accordance with the present invention;

FIG. 2 is a view taken along line 2-2 in FIG. 1; and

FIG. 3 is a sectional view of a modified form of the immersion nozzle.

### DETAILED DESCRIPTION OF AN EMBODIMENT

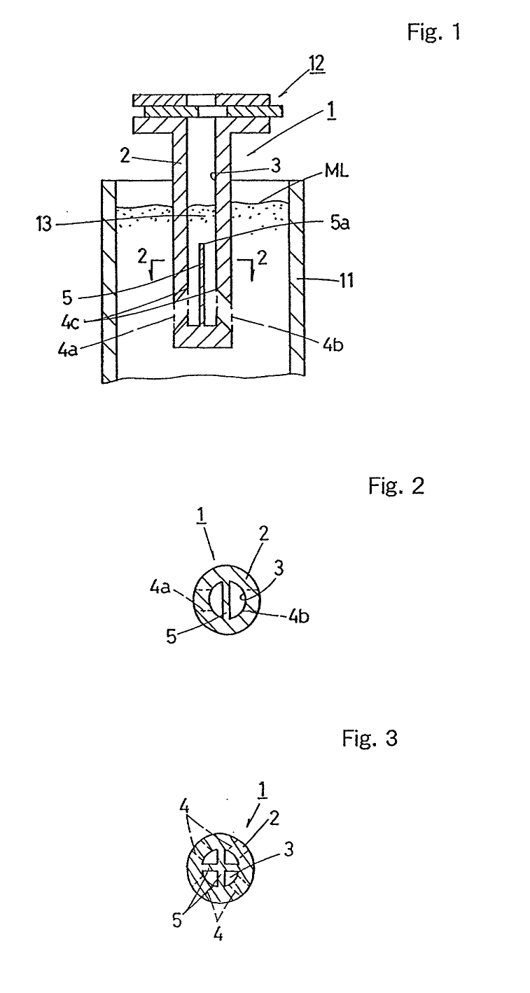

One embodiment in accordance with the present invention will be described with reference to the accompanying drawings. Referring to FIG. 1, an immersion nozzle 1 of the embodiment is shown. The immersion nozzle 1 includes a nozzle body 2 having a hollow interior 3. The body 2 has an open end and a closed end. The body 2 has two symmetrically disposed discharge holes 4a and 4b formed through a lower portion of a peripheral wall thereof so as to communicate with the interior 3. A partition wall 5 is formed integrally on a bottom of the body 2 so as to extend upward in the interior 3. The partition wall 5 divides a sectional area of the body 2 substantially in equal two parts according to the number of discharge holes 4a and 4b. The partition wall 5 has an upper end 5a located substantially midway between an open upper edge 4c of an inner opening of each discharge hole 4a, 4b and a meniscus line ML of molten steel during immersion.

The above-described immersion nozzle 1 is immersed in molten steel filling a mold 11 so that the molten steel is supplied through the discharge holes 4a and 4b. A slide gate 12 is mounted on the upper open end of the body 2. An opening of the slide gate 12 is varied so that a casting speed is adjusted. When the slide gate 12 is full open, the molten steel flowing into the interior 3 of the nozzle 1 is divided by the partition wall 5 so that amounts of molten steel discharged out of the respective discharge holes 4a and 4b are substantially equalized.

When the opening of the slide gate 12 is reduced, the molten metal flows through the slide gate 12 toward a well 13 in the interior 3 obliquely from above. However, force of the molten steel flowing obliquely downward is blocked or reduced by the partition wall 5. Furthermore, the upper end 5a of the partition wall 5 is located substantially midway between the open upper edge 4c of each discharge hole 4a, 4b and the meniscus line ML. Accordingly, the head pressure of the molten steel accumulated between the upper end 5a of the partition wall 5 and the meniscus line ML causes the molten steel to flow downward. Consequently, amounts of molten steel discharged out of the respective discharge holes 4a and 4b are substantially equalized, whereupon the one-side flow of the molten steel can reliably be prevented.

The effect of the partition wall 5 was experimentally confirmed regarding the immersion nozzle 1 formed with the foregoing partition wall 5 and another immersion nozzle without the partition wall. Water was used instead of the molten steel. A flow velocity (cm/sec) of water flowing out of each discharge hole 4a, 4b was measured when the opening of the slide gate 12 was 100% and 50%. TABLES 1 and 2 show the results of measurement.

TABLE 1
Flow velocity at each discharge hole when opening of slide
gate is 100% (cm/sec)

| | |
|---|---|
| With partition wall | Without partition wall |

| | Discharge | Discharge | Discharge | Discharge |
|---|---|---|---|---|
| | hole 4a | hole 4b | hole 4a | hole 4b |
| Data 1 | 99.9 | 99.7 | 90.2 | 87.8 |
| Data 2 | 93.7 | 94.4 | 84.4 | 88.1 |
| Data 3 | 105.7 | 105.1 | 96.0 | 86.0 |
| Average | 99.8 | 99.7 | 90.2 | 87.3 |

| | | |
|---|---|---|
| Difference | 0.1 | 2.9 |
| between | | |
| averages | | |

TABLE 2
Flow velocity at each discharge hole when opening of slide
gate is 50% (cm/sec)

| | |
|---|---|
| With partition wall | Without partition wall |

| | Discharge | Discharge | Discharge | Discharge |
|---|---|---|---|---|
| | hole 4a | hole 4b | hole 4a | hole 4b |
| Data 1 | 84.4 | 83.3 | 98.3 | 61.4 |
| Data 2 | 90.0 | 90.8 | 100.9 | 66.6 |
| Data 3 | 80.9 | 81.0 | 97.0 | 57.4 |
| Average | 85.1 | 85.0 | 98.7 | 61.8 |

| | | |
|---|---|---|
| Difference | 0.1 | 36.9 |
| between | | |
| averages | | |

As shown in TABLE 1, when the opening of the slide gate 12 is 100%, the difference between the averages of flow velocity of water flowing through the discharge holes 4a and 4b is 0.1 cm/sec regarding the immersion nozzle 1 with the partition wall 5. The difference is 2.9 cm/sec regarding the immersion nozzle without the partition wall 5. Accordingly, the flow velocity at the discharge holes 4a and 4b, that is, amounts of water discharged out of the respective discharge holes 4a and 4b can substantially be equalized.

Further, as shown in TABLE 2, when the opening of the slide gate 12 is 50%, the difference between the averages of flow velocity of water flowing through the discharge holes 4a and 4b is 0.1 cm/sec regarding the immersion nozzle 1 with the partition wall 5. The difference is 36.9 cm/sec regarding the immersion nozzle without the partition wall 5. Accordingly, the results of measurement indicate a conspicuous effect of the partition wall 5, that is, the effect of substantially equalizing the flow velocity at the discharge holes 4a and 4b, that is, amounts of water discharged out of the respective discharge holes 4a and 4b. Although the above-described effect was achieved from the water, the molten steel can be expected to provide the same effect.

The body 2 of the immersion nozzle may have more discharge holes, and the partition wall 5 may partition the sectional area of the body 2 substantially in more equal parts according to the number of discharge holes. FIG. 3 shows a modified form in which the body 2 has four discharge holes 4 and the partition wall 5 divides the sectional area in four equal parts.

The foregoing description and drawings are merely illustrative of the principles of the present invention and not to be construed in a limiting sense. Various changes and modifications will become apparent to those of ordinary skill in the art. All such changes and modifications are seen to fall within the scope of the invention as defined by the appended claims.

We claim:

1. An immersion nozzle for continuous casting comprising:
a body having a hollow interior and an open end and a bottom, the body including a peripheral wall and having a plurality of discharge holes formed through the peripheral wall so as to communicate with the interior of the body and so as to be located near one of the ends thereof; and
a partition wall formed integrally on the bottom of the body so as to divide a sectional area of the body substantially in equal parts according to the number of discharge holes so that amounts of a molten metal discharged out of the respective discharge holes are substantially equalized, the partition wall having an upper end located above the discharge holes and below a meniscus line of the molten metal.

2. An immersion nozzle according to claim 1, wherein the upper end of the partition wall is located substantially midway between an open upper edge of an inner opening of each discharge hole and the meniscus line.

3. An immersion nozzle according to claim 1, further comprising a slide gate provided for opening and closing the open end thereof.

4. An immersion nozzle according to claim 2, further comprising a slide gate provided for opening and closing the open end thereof.
